(19) United States
(12) Patent Application Publication
(10) Pub. No.: US 2014/0337375 A1
(43) Pub. Date: Nov. 13, 2014

(54) DATA SEARCH AND STORAGE WITH HASH TABLE-BASED DATA STRUCTURES

(71) Applicant: Exeray Inc., Danville, CA (US)

(72) Inventor: Jonathan Zhanjun Yue, Danville, CA (US)

(73) Assignee: Exeray Inc., Danville, CA (US)

(21) Appl. No.: 14/103,452

(22) Filed: Dec. 11, 2013

Related U.S. Application Data
(60) Provisional application No. 61/855,085, filed on May 7, 2013.

(51) Int. Cl. G06F 17/30

(52) U.S. Cl. CPC G06F 17/30424
USPC 707/769

(57) ABSTRACT

Provided are computer devices and methods for improved data storage, indexing and search. The methods entail the use of hash tables incorporated into nodes of search trees so as to increase the capacity of the nodes and reduce the size of the tree; hence reducing the time to identify a node while searching in the tree. The hash tables are so structured to maintain the hierarchy of the search tree and speed up the search within the hash table.

### CROSS-REFERENCE TO RELATED APPLICATIONS

This application claims the benefit under 35 U.S.C. §119(e) to U.S. provisional application Ser. No. 61/855,085, filed May 7, 2013, the contents of which are incorporated here by reference in its entirety.

### BACKGROUND

The present disclosure, in general, relates to computer devices and methods for storing, indexing and searching data in computer memory. The trend of increasingly large data sets and high velocity data calls for efficient data storage structure and methods.

Historically, the information technology industry has utilized binary search tree (BST) for storing and indexing data. BST is a node-based binary tree data structure where left subtrees contain only keys that are less than the key in the parent node, and right subtrees contain only keys that are greater than the key in the parent node. A subtree of tree T is a tree consisting of a node in T and all of its descendants in T. Another type of BST is T−tree, in which each node contains an ordered array of keys, a left child node, and/or a right child node.

In addition to BST's, B−tree which is a multi-way search tree has also been used for data storage and indexing. B−tree keeps data sorted and allows searches, sequential access, insertions, and deletions in logarithmic time. The B−tree is a generalization of a binary search tree in that a node can have more than two children. Unlike self-balancing binary search trees, the B−tree is optimized for systems that read and write large blocks of data. It is commonly used in databases and file systems.

Hash tables are usually involved in data lookup. Hash tables can map keys to values. A hash table uses a hash function to compute an index into an array of buckets or slots, from which the correct value can be found. The hash function can assign each key to a unique bucket, ideally, but this ideal situation is rarely achievable in practice (unless the hash keys are fixed; i.e. new entries are never added to the table after it is created). Instead, most hash table designs assume that hash collisions-different keys that are assigned by the hash function to the same bucket—will occur and must be accommodated in some way.

In many situations, hash tables turn out to be more efficient than search trees or any other table lookup structure. For this reason, they are widely used in many kinds of computer software, particularly for associative arrays, database indexing, caches, and sets. Hash tables, however, do not offer ordered search. Further, the cost of resizing a hash table is aggravated as data size becomes large.

### SUMMARY

The present disclosure provides, in one embodiment, computer methods and systems for data storage, indexing and search, which incorporate tree structures and hash tables. In accordance with one aspect of the present disclosure, provided is a method of searching a query key in a data storage, comprising accessing, by a computer, a binary tree comprising a plurality of nodes, wherein at least one of the nodes is a root node, each node has no more than two child nodes, a left child node and a right child node, and at least one node that is not the root node has both child nodes, and wherein each node comprises a hash table to store one or more keys, all of which are greater than all keys stored in the left child node, if any, thereof, and are smaller than all keys stored in the right child node, if any, thereof; (b) determining, starting at the root node, whether the query key is between the largest key and the smallest key stored in the node; and (c) if the query key is greater than the largest key in the node, (i) repeating steps (b) and (c) at the right child node thereof or (ii) terminating the search if no right child node exists, thereby determining that the query key does not exist in the binary tree, if the query key is smaller than the smallest key in the node, (i) repeating steps (b) and (c) at the left child node thereof or (ii) terminating the search if no left child node exists, thereby determining that the query key does not exist in the binary tree, if the query key is not greater than the largest key and not smaller than the smallest key in the node, searching the node to (i) find the query key or (ii) determine that the query does not exist in the binary tree if the query key is not found in the node.

In some aspects, the hash table in each node comprises a plurality of buckets, each bucket configured to store one or more keys. In some aspects, the keys in each bucket are sorted.

In some aspects, each key is further associated with a forward reference directed at the smallest key of all keys, if any, in the hash table that are greater than the key and a backward reference directed at the largest key of all keys, if any, in the hash table that are smaller than the key.

In some aspects, the binary tree comprises at least four, or five, or six or more layers of nodes. In some aspects, each node comprises a reference directed at each of the parent and child nodes thereof and each of the parent and child nodes thereof comprises a reference directed at said node.

Also provided, in one embodiment, is a method of searching a query key in a data storage, comprising (a) accessing, by a computer, a hash structure in the storage, which hash structure comprises (1) a first array (O[m]) that comprises m keys where the keys are sorted in the first array, (2) a second array (E[m]) of at least the same size (m) as the first array, which second array comprises, at each position (i), hash value of the key (O[i]) located at the same position (i) in the first array with a hash function (hash_f), that is, E[i]=hash_f(O[i]), and (3) a third array (I[n]) having a size (n) that is larger than the size (m) of the first array, wherein the values (E[i]'s) in the second array (E) are non-negative integers, and wherein the third array comprises, at the E[i]th position, the position (i) of the key O[i] in the first array; (b) obtaining the hash value (h) of the query key with the hash function; (c) obtaining the value at position (h) of the third array, I[h]; and (d) locating the query key at position (I[h]) of the first array.

In some aspects, the size (n) of the third array is at least 1.3 times of the size (m) of the first array. In some aspects, the data storage comprises a tree having a plurality of nodes and each node comprises at least a hash structure of step (a), and wherein the nodes do not overlap in terms of ranges of keys stored in each hash structure.

In some aspects, the tree is a binary tree. In some aspects, the tree is a B−tree or a B+tree.

Computer systems and non-transitory computer-readable medium are also provided with embedded program code to carry out the disclosed methods.

### BRIEF DESCRIPTION OF THE DRAWINGS

Provided as embodiments of this disclosure are drawings which illustrate by exemplification only, and not limitation, wherein:

FIG. 1 is a block diagram illustrating the top-level data structure of present disclosure;

FIG. 2 is a block diagram illustrating the components of each node in the Simple Abax Tree (SAT);

FIG. 3 is a flow chart illustrating the flow of control in searching a key in SAT;

FIG. 4 is a flow chart illustrating the control flow of inserting a key into SAT;

FIG. 5 is the detailed flow chart in replacing a key in current node in SAT;

FIG. 6 is diagram illustrating split of parent node into left-child node;

FIG. 7 is a diagram illustrating split of parent node into right-child node;

FIG. 8 is a block diagram illustrating the greatest lower node of a SAT;

FIG. 9 is a block diagram illustrating the least upper node of a SAT;

FIG. 10 is a block diagram illustrating ordered list of keys in one Abax node;

FIG. 11 is a schematic diagram illustrating forward and backward pointers that connect keys in order;

FIG. 12 is a schematic diagram illustrating inserting a key leading to updating of forward and backward pointers;

FIG. 13 is a flow chart diagram illustrating key delete operation;

FIG. 14 is a schematic diagram illustrating Abax node index (ANI) and Abax node store (ANS);

FIG. 15A is a diagram illustrating embodiment of ANI with an array of key-value pairs;

FIG. 15B is a diagram illustrating embodiment of ANI with a linked list of key-value pairs;

FIG. 15C is a diagram illustrating embodiment of ANI with a BST of key-value pairs;

FIG. 15D is a diagram illustrating embodiment of ANI with any ordered-map of key-value pairs;

FIG. 16A is a diagram illustrating embodiment of ANS with a linked list of Abax nodes;

FIG. 16B is a diagram illustrating embodiment of ANS with an Abax tree;

FIG. 17A is a flow diagram illustrating a method of searching for a key in ANS with ANI.

FIG. 17B is a flow diagram illustrating a method of inserting a key into an Abax node in linked list with ANI.

FIG. 17C is a flow diagram illustrating a method of deleting a key from an Abax node in linked list with ANI.

FIG. 18 is a diagram illustrating data access in two-level ANIANS storage system;

FIG. 19 is a block diagram illustrating buffered access to two-level Abax storage system; and

FIG. 20 illustrates three arrays and their relationship in a mini-hash table.

It will be recognized that some or all of the figures are schematic representations for exemplification and, hence, that they do not necessarily depict the actual relative sizes or locations of the elements shown. The figures are presented for the purpose of illustrating one or more embodiments with the explicit understanding that they will not be used to limit the scope or the meaning of the claims that follow below.

### DETAILED DESCRIPTION

This disclosure, in one embodiment, provides new types of structure for data storage and key-value lookup. The new data structures exhibit the features of both search tree and hash table, and can be considered as ordered-hash tables.

### Abacus-Like Hash Table-Embedded Search Tree (Abax Tree)

In one embodiment, the present disclosure provides computer methods and systems for storing, indexing and searching data, with a hash table-embedded search tree, where the node keys are organized like an abacus, hence named “Abax tree.”

In some aspects, an Abax tree refers to a binary tree that includes a plurality of nodes, wherein at least one of the nodes is a root node, each node has no more than two child nodes, a left child node and a right child node, and at least one node that is not the root node has both child nodes, and wherein each node comprises a hash table to store one or more keys, all of which are greater than all keys stored in the left child node, if any, thereof, and are smaller than all keys stored in the right child node, if any, thereof.

Such an Abax tree is binary and can be viewed as embedding hash tables into one or more of the binary nodes. An Abax tree, however, can also take other forms, such as that of a B−tree, B+tree, T−tree, multi-way search tree, or any other type of search trees. Like in a binary Abax tree, for instance, a B−tree based Abax tree embeds hash tables into one or more nodes of a B−tree, so long as all the keys stored in a hash table are within the range defined with the adjacent or connected nodes.

The keys in each node of an Abax tree, also referred to as an “Abax node,” can be mapped to a plurality of buckets with a hash function. The number of keys stored in one Abax node may be very large (for instance, millions of keys in one node or even more), thus drastically reducing the height of the tree and improving data accessing speed. Abax nodes are dynamically split and merged locally requiring no global operation in the tree. Hash collisions are resolved with storage space of controlled size so that search time in a bucket is constant.

Two types of Abax trees are described in detail in the present disclosure. The first, named “Simple Abax Tree” (SAT) or simply an “Abax tree”, is relatively a simple structure of Abax tree. The second, named “Composite Abax Tree” (CAT), is a composite tree that is structured similarly to an SAT except that each bucket contains a Simple Abax Tree. Once the structure of a SAT is shown, it will be clear how a CAT is organized.

The disclosure then introduces the ANIANS data structure and related methods where a separate indexing structure, Abax Node Index (ANI), is built and queried for fast accessing to Abax nodes in a Abax Node Store (ANS).

### Structure of an Abax Tree

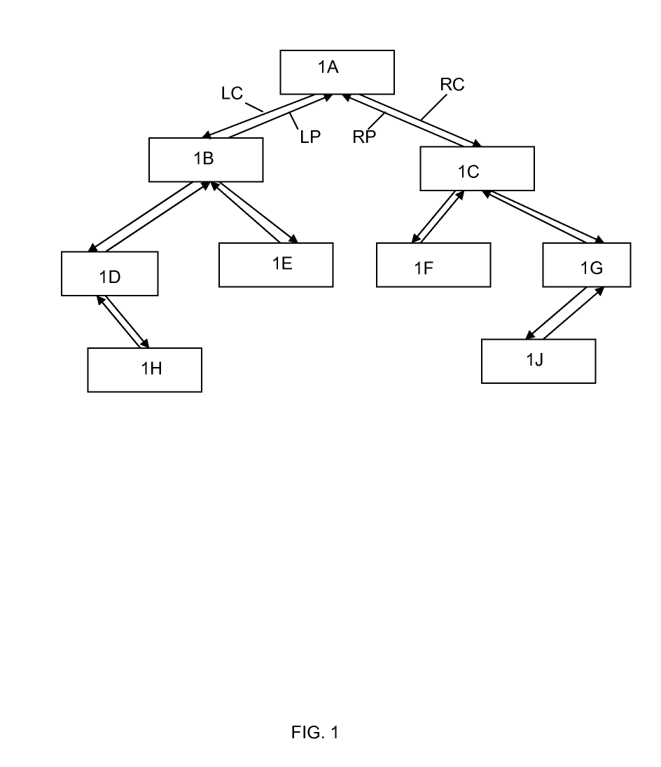

FIG. 1 is a schematic diagram illustrating the high-level overview of a simple Abax tree (SAT). Node 1A is the root node of a SAT. Nodes 1B and 1C are left and right child nodes of their parent node 1A. A node may have zero number of child nodes, or one left child node, or one right child node, or both left and right child nodes. In this presentation, a child is equivalent to a child node. LC is a pointer in parent node 1A storing the address of left child node 1B. In computer science, a pointer holds the address of another data block in memory. LP is a pointer in left child node 1B storing the address of its parent node 1A. RC is a pointer in parent node 1A storing the address of right child node 1C. RP is a pointer in right child node 1C storing the address of its parent node 1A. The value of LP is the same as the value of RP since both points to the same node 1A. Pointers LC and LP form double links between parent node and child node. Pointers from child nodes to parent nodes are optional, but they make tree-balancing process faster. Nodes 1D and 1E are the left and right child nodes, respectively, of their parent node 1B. Node 1H is the only (right) child of node 1D. Nodes 1F and 1G are the left and right child nodes, respectively, of node 1C. Node 1J is the only (left) child node of node 1G. SAT grows by attaching more child nodes to existing nodes or by splitting nodes into more nodes. The SAT meets the comparison constraint that is the same as in BST: a left subtree of a parent node contains only keys that are less than the keys in the parent node, and a right subtree of a parent node contains only keys that are greater than the keys in the parent node.

As a SAT grows larger, the tree may become unbalanced. SAT is balanced with tree rotation technique after a new node is added to a SAT. Embodiments of balancing a SAT include AVL tree balancing method, RedBlack tree balancing mechanism, or any other binary tree balancing method. A person skilled in the art will be familiar with the requisite techniques.

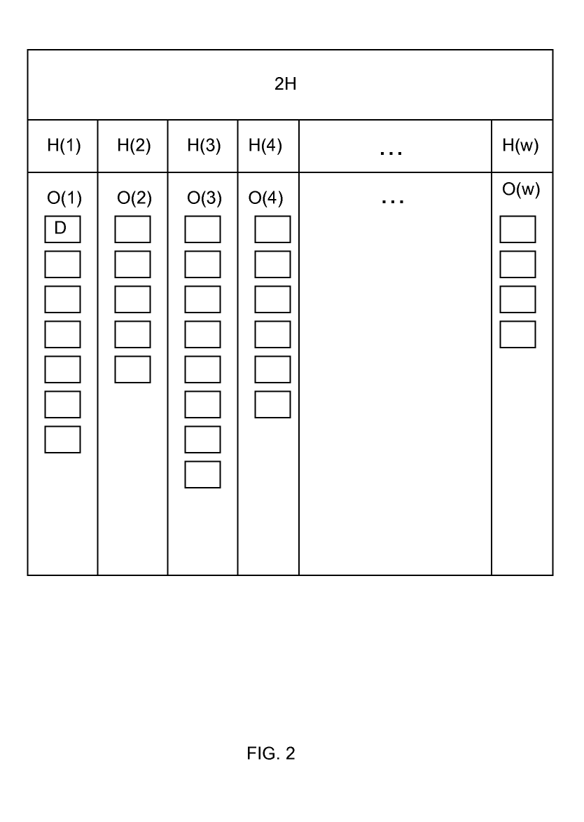

FIG. 2 is a block diagram illustrating the components of each node in an SAT. In the SAT tree node, there is a header 2H, and a plurality of buckets where keys are hashed and stored. Header 2H contains metadata which may include the following information: pointers to left and right child nodes, pointer to parent node, minimum key in the node, maximum key in the node, address of the minimum key, address of the maximum key, count of keys in the node, number of buckets in the node, maximum number of keys allowed in each bucket. The SAT node is a bounding box of keys. The lower bound of all keys in the node is the minimum key stored in the node; and the upper bound of all keys in the node is the maximum key stored in the node. All the Abax nodes are disjoint, that is, the keys in different nodes belong to disjoint ranges. In the SAT node, there is a plurality of buckets numbered from 1, 2, . . . to w, where w represents the total number of buckets in the node. The buckets hold keys that are mapped through a hash function. Output value of the hash function is a number between 1 and w inclusive which is the index of the bucket that the input key will be stored. Embodiments of hash function include Congruential Hashing, Murmur hash, CityHash, Universal Hashing, or any good hash function. A good hash function should distribute keys as evenly as possible over all the buckets.

In each of the buckets, keys are stored in an Abax Chain (AC) which is a data storage structure that allows fast access to the keys in the bucket. The capacity of an AC is the maximum number of keys that may be stored in the AC. Embodiments of the present disclosure include three types of AC: the first is simply an ordered array of keys, denoted by SAC; the second is a perfect hash chain, denoted by HAC; the third is an order-preserving perfect hash chain, denoted by OHAC. The maximum length, namely the capacity, of the chain is denoted by D (or d). A bucket is full when the number of keys in the bucket is equal to the capacity D. The value of D may be a fixed number for the whole SAT, or a variable as a function of the height of a node.

In some aspects, the capacity d is large enough to minimize overflow and node split. For instance, suppose,

Horizontal: number of buckets=B

Vertical in each bucket: number of slots=D

Total number of keys to be stored in all buckets=T

The probability that any bucket will overflow (number of keys>D in a bucket):

$$P = 1 - {\sum }_{i = 0}^{D} \frac{T !}{i ! ( T - i ) !} {( 1 / B )}^{i} {( 1 - 1 / B )}^{( T - i )}$$

let F=fD where f is the average load-factor of all the buckets. Then T=FB=fDB.

So we have B=T/(fD)

Assuming T is fixed, the overflow probability P will be a function of (f, D):

$$P ( f , D ) = 1 - {\sum }_{i = 0}^{D} \frac{T !}{i ! ( T - i ) !} {( fD / T )}^{i} {( 1 - fD / T )}^{( T - i )}$$

When a desired value of f is set (for example to 0.95), then P will decrease as the value of D increases. This means a bucket with more slots will reduce the probability of overflow hence smaller probability of node-splitting. However if the value of D is too big, insert and delete operations will be negatively affected.

Accordingly, in some aspects, the capacity D is at least 128. In one aspect, and number of buckets in each node is at least 1280 and the total number of keys in a node is at least 163,840. In another aspect, the capacity D is not greater than 195.

In another embodiment, keys may be inserted into a different bucket, the overflow bucket, in the same node when the original bucket for the keys is full. In one embodiment, we select the bucket that contains the minimum number of keys as the overflow bucket. In this case we add an overflow pointer in the original bucket so we track the overflow keys. This technique increases the average load-factor of Abax nodes by a few percent.

The product of d and w is the capacity, denoted by C, of an Abax node. When a greater value of d is used in Abax tree, insert and search operations tend to slow down, but the Abax nodes are more densely populated and fewer node-splits occur. The capacity C of an Abax node may be programmed to vary dynamically. New nodes may be allocated with greater capacity and be rotated from lower levels to higher levels so that more keys can be queried with fewer number of levels in the tree.

In some embodiments, a SAC includes an array with sequential index from 0 to d−1. Keys are stored in the array with order determined by a user-defined key-comparison function. Inserting or deleting a key in the array may require shifting other keys in the array. Search of a key in the array can be performed by binary search in logarithmic time. Embodiments of SAC also include binary search tree, T−tree, multi-way search tree, or any other type of search tree.

In some embodiments, a HAC include a hash table populated by hashing the keys with perfect hash function (PHF). A perfect hash function for a key set is a hash function that maps distinct elements in the key set to a set of integers, with no collisions. The hash output value is an index to an array with capacity d. When the number of keys in the bucket is equal to the capacity of storage array, d, the PHF essentially becomes a minimal perfect hash function (MPHF). As the number of keys in the bucket increases, it takes longer to find the PHF. One embodiment of finding the PHF and MPHF for keys in each bucket is utilizing a hyper-graph based method. HAC provides good performance for random access but poor performance for range query.

In some embodiments, an OHAC includes a hash table populated by hashing the keys with order-preserving perfect hash function (OPPHF). In addition to the properties of PHF, an OPPHF preserves the order of the input keys, that is, the mapped integers as index to the storage array follow the same order of the input keys. When the number of keys in the bucket is equal to the capacity of storage array, d, the OPPHF becomes an order-preserving minimal perfect hash function (OPMPHF). One embodiment of finding the OPPHF and OPMPHF for keys in each bucket is utilizing the CHM method. When a new key is inserted in a HAC, a new OPPHF is found with the CHM method.

When perfect hash functions are used to hash the keys in a node, information about the hash functions such as hash function type, random number seeds, graph mapping functions, etc. are stored in the header fields of each bucket.

In FIG. 2, the i-th (i=1, 2, . . . w) bucket includes a header H(i) and an instance of Abax chain O(i). Header H(i) includes the following information: a) count of of keys stored in the chain O(i); b) structure type by which the keys are stored in ordered chain O(i). The number of keys in each bucket cannot exceed the allowed maximum number of keys, d, specified in the header 2H. The structure type includes: SAC, and HAC. Every chain O(i) consists of a plurality of keys. Element D in FIG. 2 illustratively represents a key in the first chain O(1). Without loss of generality, key D may be replaced with a composite structure which may contain a key and a value, or a key and a pointer pointing to external memory block holding a value which may be text, html, program code, blobs, image, video, or any type of data.

A SAT may be either partially ordered (PO) or completely ordered (CO). In a partially ordered SAT (POSAT), all the nodes are orderly arranged. The keys in each bucket are also stored in order if SAC or OHAC storage structure is selected by end user in all buckets. However, the complete set of keys in all the buckets are not readily presented in order. The keys in a node are only merged from all buckets at query time to generate ordered output. We merge multiple lists of ordered keys by inserting and popping elements from a binary heap which will be described later in the presentation. If the keys in each bucket are not ordered, we then simply sort all keys in the node with a fast sorting method such as quicksort. In a completely ordered SAT (COSAT), all keys in a node are kept in order whenever a key is inserted into or deleted from the node. This is achieved by maintaining an ordered linked list of keys in different buckets. When a new key is inserted into a node, we include the new key in the ordered linked list at the appropriate position so that the order is still maintained. When a key is deleted from the node, we exclude the key from the ordered linked list. At query time, the linked list is traversed directly to output an ordered list of keys without any extra merging or sorting operation. If complete order is desired by end user, then we use a pointer in each element in the Abax chain to point to one of the remaining elements in the chain. The pointer contains a global address in the memory space. Optionally, the pointer may contain a local address that has a scope of a SAT node instead of the whole memory address space. In many cases, the local address uses less memory than global address. For instance, in a 64-bit computer system, global address may require at least 6 bytes. If local address is used, it may use only 2 bytes for the index of the buckets, 1 byte for the index to the array in an SAC, using a total of only 3 bytes as opposed to the 6 bytes in the global address. One may also use position offsets from the start location of the node to compute local addresses.

### Search a Key in an Abax Tree

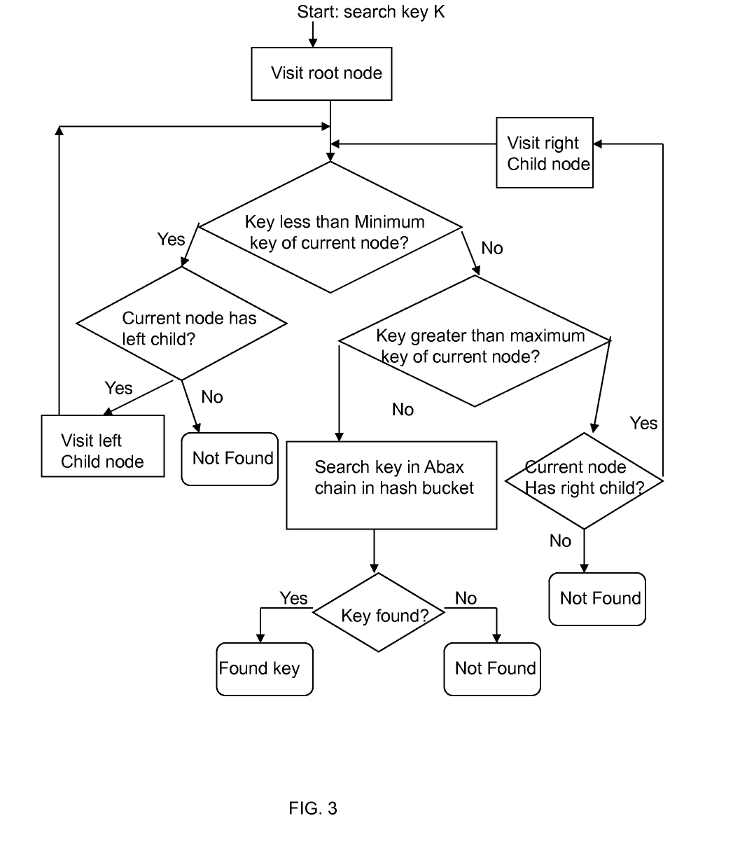

The method to search for a key in a SAT is illustrated in FIG. 3. Search starts by visiting the root node first. A node that is being visited is defined as the current node. If the search key is less than the lower bound key in the current node, then we visit and search in the left child node if the node exists. If the search key is greater than the upper bound key in the current, then we visit and search in the right child node if it exists. If the key to be found lies between the lower bound and upper bound of the current node, then we search for the key in the Abax chain. Search method in an Abax chain depends on the storage structure of AC to be described below.

### Insert a Key in an Abax Tree

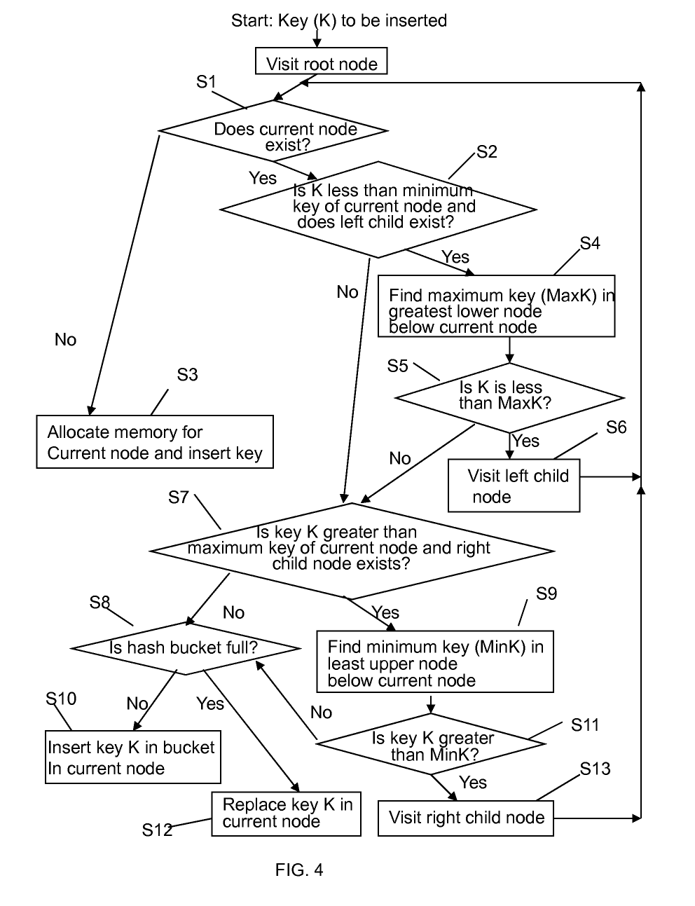

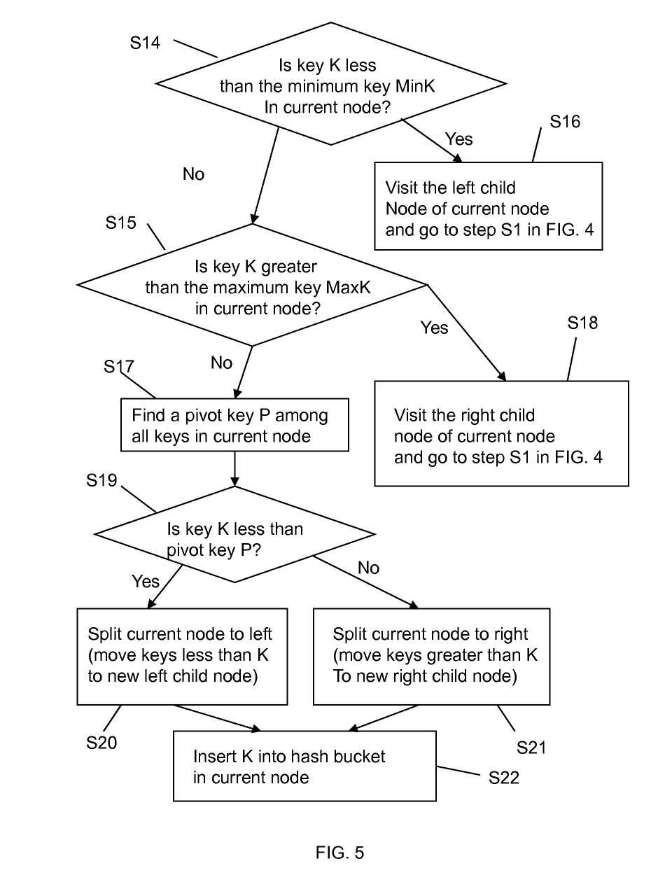

The method for inserting keys into a SAT is illustrated in FIG. 4 and FIG. 5. The control flow of inserting a key K starts by visiting the root node which is marked as the current node. Step S1 in FIG. 4 depicts the initial step when visiting any current node. The step tests whether the current node actually exists in memory as opposed to just being a null entity. In the very beginning before any key is inserted, the root node is always a null entity. So are the left child node and the right child node in the current node when no memory is allocated for them. If the test result in step S1 is negative (No), then we allocate memory for the current node, and then we insert the key into the current node. The insert operation comprises of hashing the key into a bucket, and then inserting the key as the first element in the Abax chain contained in the bucket.

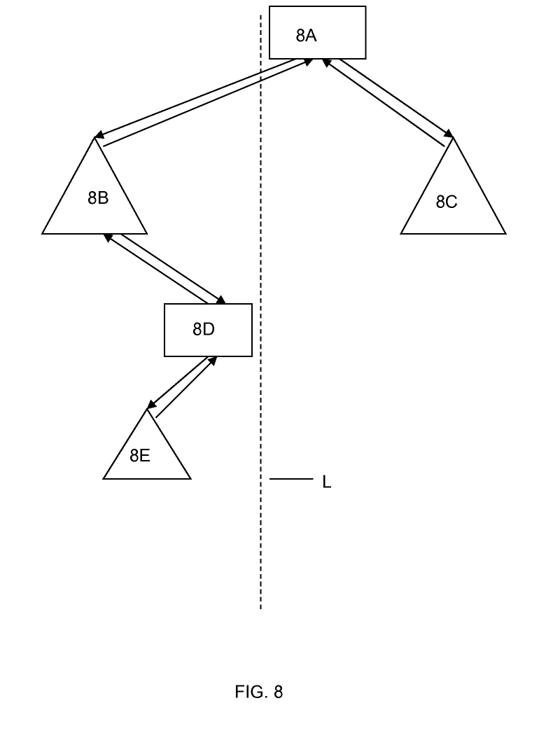

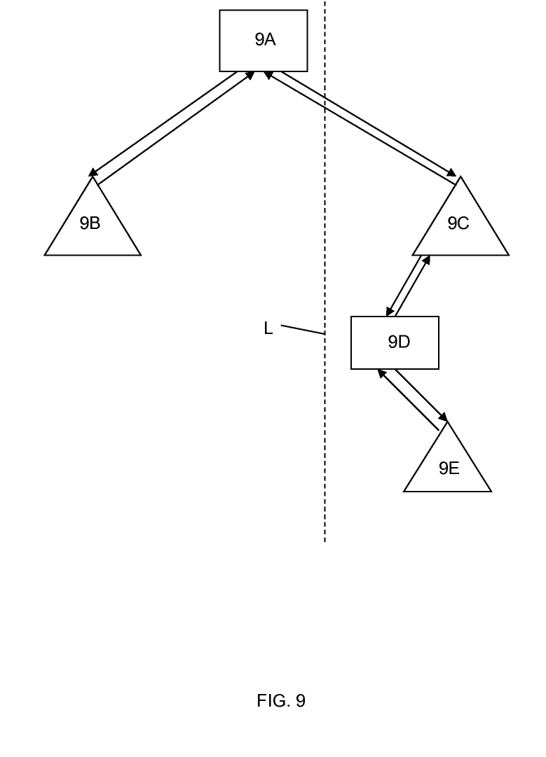

If the test result in step S1 is positive (Yes), then we compare the key K with the minimum key in the current node. If K is less than the minimum key and there exists a left child node, then control goes to step S4, otherwise the control goes to step S7. In step S4, the greatest lower node below the current node is found and the maximum key value in the greatest lower node is denoted MaxK. The greatest lower node is illustrated by node 8D in FIG. 8. Step 4 is followed by step 5, which tests if K is less than MaxK. If the test result is positive, we visit the left child node of the current node and mark the left child node as new current node. Control flow goes back to step S1 with a new current node and the control continues in a loop. If the test result of step S5 is negative, control goes to step S7. In step S7, program tests if key K is greater than the maximum key of current node and if its right child node exists. If the test result is positive, control goes to step S9, otherwise control goes to step S8. Step 9 finds the minimum key (MinK) in the least upper node below the current node. The least upper node is illustrated by node 9D in FIG. 9. A comparison operation is executed in step S11 which tests whether key K is greater than MinK. If test result is positive, then we visit the right child node of current node and mark the right child node as the new current node. The control goes back to step S1 where the loop continues. If the test result from step S11 is negative, then control goes to step S8. In step S8, key K is mapped with a hash function to generate an integer which is the index to one of the buckets in the current node. If the bucket is full, that is, the number of keys in the bucket is equal to d (maximum allowed number of keys), then control goes to step S12. If the bucket is not full in step S8, then control goes to step S10, where key K is inserted into the bucket by adding it to the Abax chain (either a SAC or a HAC) in the bucket.

Step S12 in FIG. 4 is illustrated with more detailed view in FIG. 5. Step 14 tests whether key K is less than the minimum key MinK in the current node. If the answer is yes, then as shown in step S16, we visit the left child node of the current node and control goes to step S1 in FIG. 4. If the answer is no, then control goes to step S15 which tests whether key K is greater than the maximum key MaxK in the current node. If test result is positive, then control goes to step S18, where the right child node of current node is visited and marked as current node, and control goes back to step S1 in FIG. 4.

If the test result in step S15 is negative, we find a pivot key in the current node as illustrated in step S17. The pivot key is one of the keys stored in the current node and is used to determine which keys to move from the current node to child nodes. In a preferred embodiment of the disclosure, the median of all keys stored in a node is selected as the pivot in the node. The process of finding the median of all keys in the node is expedited by recognizing the fact that all the buckets in the node contain ordered keys so that the median of medians in all buckets may be searched. One embodiment of finding the median of all bucket-medians is the divide-and-conquer method with 5-element blocks.

Another embodiment of finding the median of all keys in the current node is maintaining a median every time a key is inserted into or deleted from the current node, namely a running median. The running median is applicable in a SAT when total order of all keys is selected by end user. We use a tardy pointer pointing to the running median in the ordered linked list. The tardy pointer is a composite structure which contains an address element storing the address of a key in the node, and a trigger element for moving the tardy pointer. When the tardy pointer points exactly to the median key, the trigger value is zero. When a key greater than the running median is inserted into the node, or when a key less than the running median is deleted from the node, the trigger value in the tardy pointer is incremented by one. If the trigger value is equal to two, then we move the tardy pointer to the next greater key by updating the address element and reset the trigger value to zero. When a key less than the running median is inserted into the node, or when a key greater than the running median is deleted from the node, the trigger value in the tardy pointer is incremented by one. If the trigger value is equal to two, then we move the tardy pointer back to the previous smaller key and reset the trigger value to zero. If the trigger value is one, the tardy pointer is not moved.

Another embodiment of selecting the pivot in a node is simply picking the median in any randomly-chosen bucket. The random median in general is not equal to the exact median of all the keys in the node but is an expedient approach.

Whenever a new key is inserted into a node, we update the lower bound (minimum key) and upper bound (maximum key) header data by comparing them with the new key. If the new key is less than the current lower bound, then the lower bound is substituted by the new key. If the new key is greater than the current upper bound, then the upper bound key is substituted by the new key. In addition, the address of the lower bound key or upper bound key is also updated if the substitution happens. The addresses of lower bound and upper bound keys are needed for maintaining the ordered linked list in a node. One with skill in the art will appreciate that lower bound and upper bound keys in a node may need to be updated when keys are deleted from the node. Saving the lower bound key and the upper bound key does not require searching for them in the node when the keys are used in search or update operations to the node.

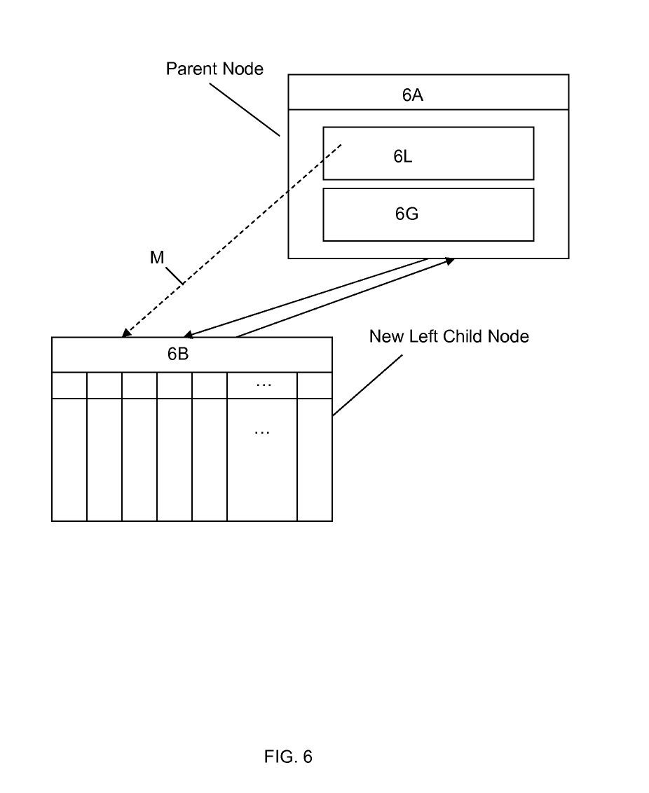

Referring to FIG. 5, in step S19, if the new key K to be inserted is less than the pivot, control goes to step S20, where we split the current node to left child node. Keys that are less than the new key K are moved to the left child node where further splits may also happen. A preferred embodiment of splitting a node is a simple split procedure which just allocates a new left child node and then moves the keys that are less than the new key K into the new left child node and re-arranges the remaining keys in current node. This simple process does not cause further node splits which slows down the insert operation due to moving of multiple keys. The simple split procedure is depicted in FIG. 6.

FIG. 6 is a schematic diagram illustrating the split of a parent node 6A into a newly allocated left child node 6B. The original left child node, if any, of 6A becomes the left child node of 6B. Node relationship change requires updates of child and parent pointers. Keys that are less than the new key K in node 6A are outlined by 6L. Keys that are greater than the new key K in node 6A are outlined by 6G. Storage memory for node 6B is allocated and buckets in the new node are created. Operation M indicates the migration of keys in the set of 6L to the new node 6B following the same insert method as described in FIG. 4 and FIG. 5. The keys in the set of 6G are re-arranged or shifted in the parent node 6A to meet the constraints of a standard SAT tree. Tree balancing operation is executed once the split is completed.

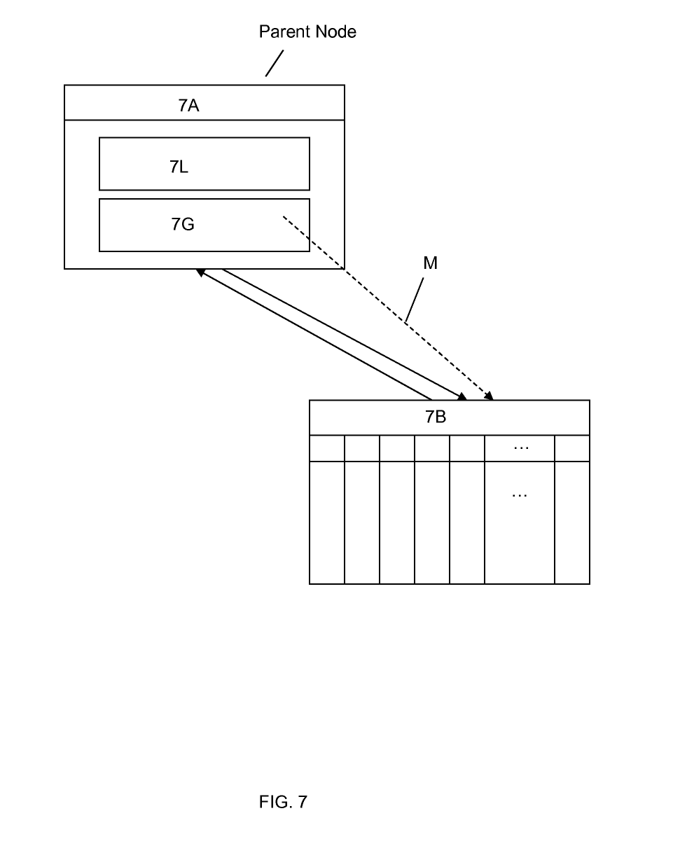

FIG. 7 is a schematic diagram illustrating the split of a parent node 7A into a new right child node 6B. The original right child node, if any, of 7A becomes the right child node of 7B, with pointer parent node updated. Keys that are less than the new key K in node 7A are outlined by 7L. Keys that are greater than the new key K in node 7A are outlined by 7G. Storage memory for node 7B is allocated and buckets in the new node are created. Operation M illustrates the migration of keys in the set of 7G to the new node 7B following the same insert method as described in FIG. 4 and FIG. 5. The keys in the set of 7L are re-arranged or shifted in the parent node 7A to maintain a standard SAT tree structure. Tree balancing operation is executed once the split is completed.

FIG. 8 illustrates the greatest lower node of a node in SAT. Node 8A may be any node in the tree. If node 8A has a left subtree, then the greatest lower node is the node that contains a group of keys which are less than the keys in node 8A but greater than all the keys in the remaining nodes that belong to the left subtree of node 8A. Node 8D is shown as the greatest lower node of node 8A. Node 8D must not contain a right child node, but may contain a left subtree. Viewed graphically on a two-dimensional plane, the greatest lower node 8D is the right-most node on the left side node 8A. Line L separates out the left subtree of node 8A. Node 8D has the shortest horizontal distance to line L among all other nodes in the left subtree of 8A. Programmatically the left child node of 8A is first visited, then the program continues visiting only the right child node as the program drill-down the levels of nodes. If the right child node does not exist in one visited node, then the program stops and the last-visited node is the greatest lower node of 8A. The maximum key in the greatest lower node is useful for insert operation in a SAT.

FIG. 9 illustrates the least upper node of a node in SAT. Node 9A may be any node in the tree. If node 9A has a right subtree, then the least upper node is the node that contains a group of keys which are greater than the keys in node 9A but less than all the keys in the remaining nodes belonging to the right subtree of node 9A. Node 9D is shown as the least upper node of node 9A. Node 9D must not contain a left child node, but may contain a right subtree. Viewed graphically on a two-dimensional plan, least upper node 9D is the left-most node on the right side node 9A. Line L separates out the right subtree of node 9A. Node 9D has the shortest horizontal distance to line L among all other nodes in the right subtree of 9A. Programmatically the right child node of 9A is first visited, then the program continue visiting only the left child node as the program drill-down the levels of nodes. If the left child node does not exist in one visited node, then the program stops and the last-visited node is found as the least upper node of 9A. The minimum key in the least upper node is useful for insert operation in a SAT.

### Ordered Linked List in an Abax Tree

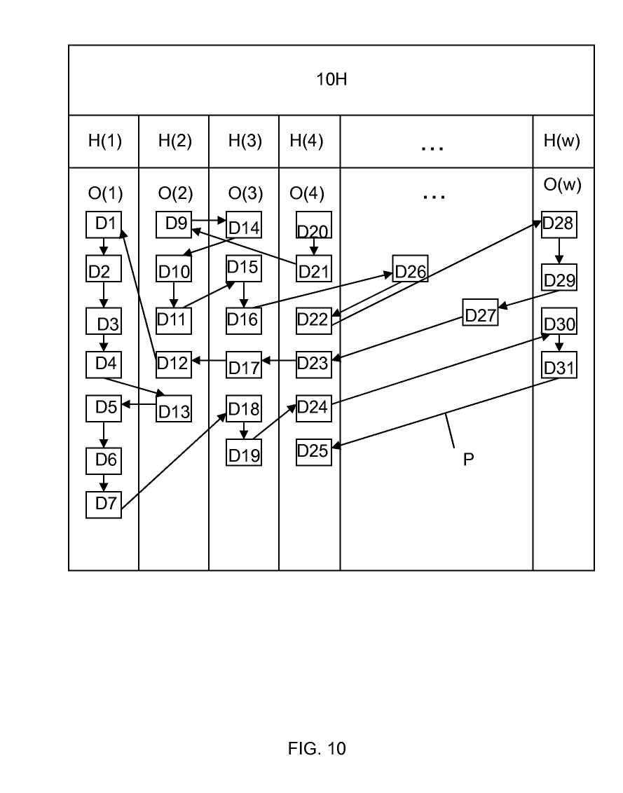

FIG. 10 is a block diagram illustrating the keys that are linked by pointers to form an ordered linked list in a SAT node 10H. The linked list and related pointers are built and maintained if end user selects to have a completely-ordered SAT. Key D20 is the least key and key D25 is the greatest key in the node. All the keys in the node are linked with pointers such as pointer P which is shown with an arrow indicating the direction of order. Pointer P contains both a forward pointer and a backward pointer. The keys D1, D2, . . . D31 contained in the Abax chains are linked with forward and backward pointers. When a new key is inserted into an AC, pointers are reconnected to include the new key into the linked list at the appropriate position to maintain the correct order. Normally insert of an element in a linked list requires traversal of the list from the beginning of the list. Because each Abax chain is ordered, the predecessor of the new key is found in the node and used to include the new key into the list. To delete a key from the linked list, the key is first located and then removed from the list by reconnecting pointers in its two adjacent keys.

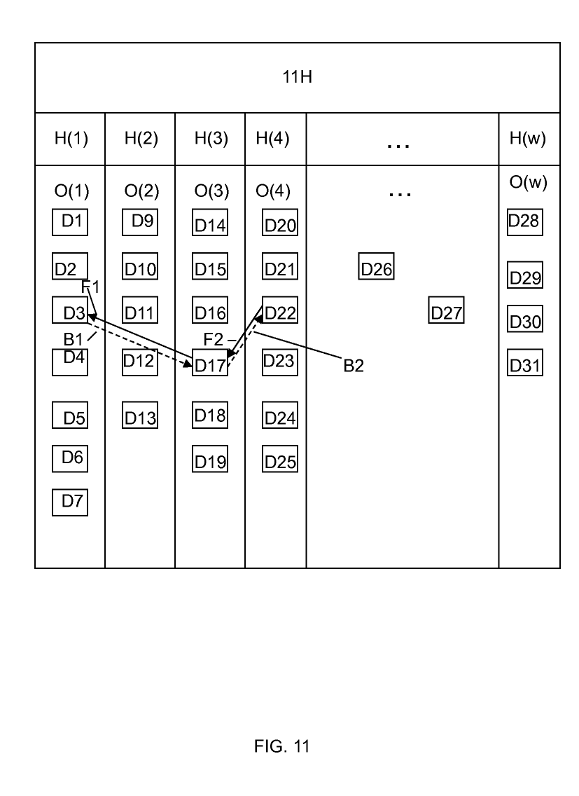

A segment of the ordered linked list is illustrated in FIG. 11. Keys D22, D17, and D3 are linked with forward pointers F2 and F1, and backward pointers B2 and B1. Forward pointers provide normal order while backward pointers provide reverse order. When a key K is deleted from an AC in a bucket, the keys that are greater than the deleted key K may need to be shifted in the chain depending on the specific type of storage used in the Abax chain. If the local address of any key M is changed, the keys that point to the key M or the keys being pointed by the key M need to have their forward pointer or backward pointer updated. The pointer updates apply to key insert operation too. In the case of simple array storage type for an AC, only the AC array index is updated for the shifted keys and affected keys, bucket index remaining the same.

Insertion of a new key to SAT with ordered linked list can also be carried out readily. Because the keys in the bucket are sorted, one can use binary search for the key that is the successor of the new key. A successor of the new key is the minimum key from all the keys that are greater than the new key in the bucket.

Once the successor is found, shift the successor and all the keys that are greater than the successor down one position (in the direction of greater keys). Finally, the new key can be inserted into the original successor location.

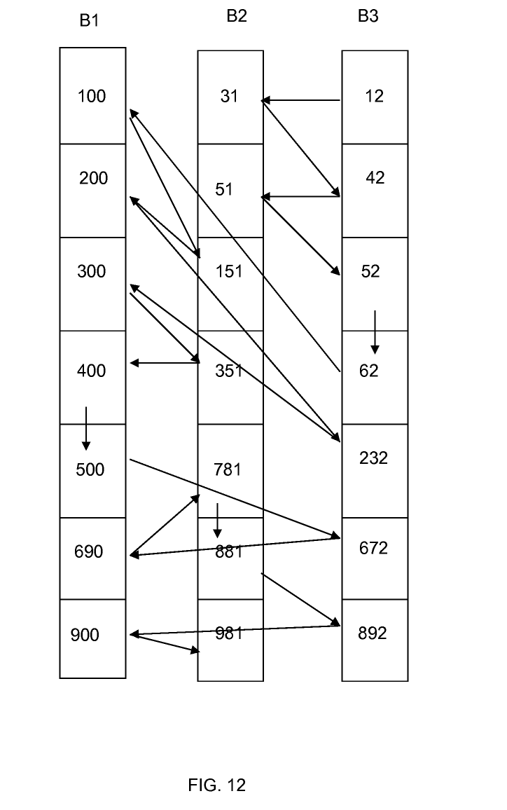

Forward and backward reference links can be updated as follows, without limitation. In method 1, for instance, go to the predecessor of the new key in the same bucket, perform standard insert operation in a linked list starting from the predecessor. With reference to FIG. 12, suppose new key is 182 and is hashed to bucket 3. The predecessor of 182 is key 62. The forward reference of 62 takes us to key 100 in bucket 1. Key 100 is still less than the new key 182, so we go to next key in the link which is key 151 in bucket 2. 151 is still less than 182, so we go to next key which is 200 in bucket 1. Now 200 is greater than the new key 182. So we placed the new key 182 between 151 and 200 by updating the reference links of 151 and 200.

For another example, at a first step a), go to the predecessor of the new key in the same bucket. Then, at step b), go to the next key of the predecessor by following the forward reference. In the bucket that contains the next key, perform a binary search starting from the position of the next key to find the predecessor of the new key in the bucket; step c) repeat step b in until the predecessor key of the new key is found; step d) perform standard insert operation in a linked list. Also, with reference to FIG. 12, suppose new key is 662 and is hashed to bucket 3. The predecessor of 662 in the same bucket is 232. Follow the forward reference link of 232 to key 300 in bucket 1. Starting from key 300 in bucket 1 we perform a binary search of predecessor for 662. Key 500 is found to be the predecessor of 662 in bucket 1. Follow the forward link of 500 to key 672 in bucket 3. Now 672 is greater than the new key 662 and the link-following steps are terminated. So 662 should be inserted between 500 and 672 by updating the forward and backward references of keys 500 and 672.

### Delete a Key in an Abax Tree

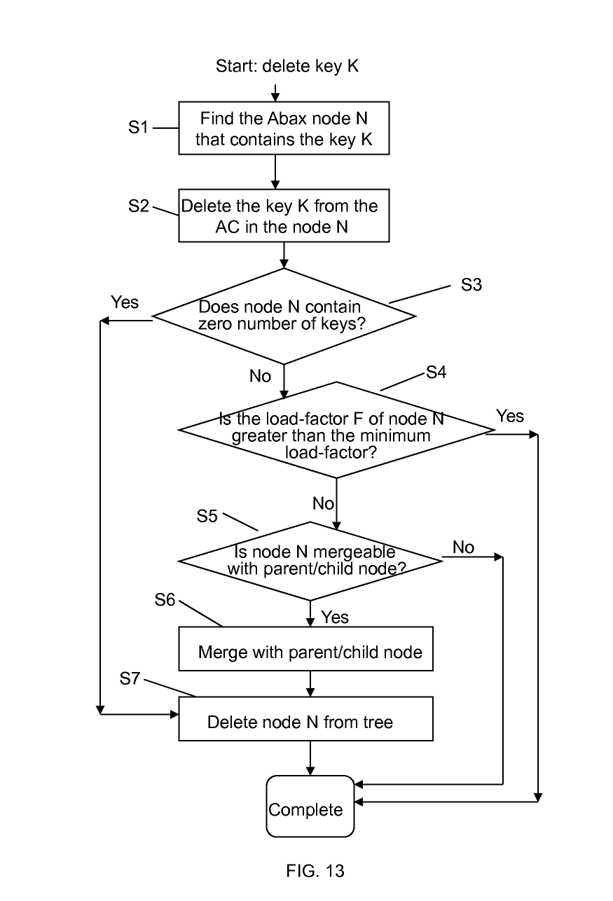

Delete operation is illustrated in FIG. 13 showing the control flow of deleting a key K from a SAT tree. Step S1 in FIG. 13 we find the node N that contains the key K. If the node is not found, then the operation terminates. Control goes to step S2 from S1. In step S2, we delete the key K from the Abax chain in node N. We rearrange the remaining keys in the chain, update linked list pointers if used, update the minimum and maximum keys in the node, update the count of keys in the node, and update other related metadata in the node. Then in step S3, program tests if there are no more keys left in the node. If the test result is positive (Yes), then the node N is deleted from the tree by reattaching child and parent pointers. If there are still keys left in the node N, then control goes to step S4, where a load-factor F, the percentage of number of keys existing in the node over the total number of keys allowed in the node, is compared against a minimum load-factor FMIN. If the load-factor F is greater than FMIN, then no further step is executed and the delete operation is completed. If the load-factor F is not greater than FMIN, then control goes to step S5. Step S5 tests whether the node N is mergeable to its parent node, or left child node, or right child node. We take keys in a source node and a destination node and merge the keys into the destination node to make efficient use of memory. A source node is said to be mergeable to a destination node if the storage space of the destination node is sufficiently large to accommodate all the keys combined from the two nodes. With any pair of Abax nodes that contain the same number of buckets, the two nodes are mergeable if for each bucket the total number of the keys in the corresponding buckets does not exceed the capacity of the bucket in the destination node. With any pair of Abax nodes that have different number of buckets, the two nodes are mergeable if rehashing and storing all the keys in both nodes into the destination node would not cause overflow in any bucket in the destination node. If the test result of step S5 is negative (No), then no further action is taken and the delete operation is completed. If the test result is positive, then we merge the node N onto the mergeable destination node which could be a parent node, a left child node, or a right child node by taking the keys from node N and inserting them into the destination node. The control then goes from step S6 to step S7. In step S7 we remove the node from the tree by reattaching child and parent pointers without copying any keys between the tree nodes. Removal of a node also frees the storage space of the node.

A SAT is balanced with tree rotation whenever a child node is allocated and added into the SAT tree from operations of either inserting keys or splitting Abax nodes. If end user does not require an Abax tree to be balanced, then tree rotation is not executed.

### Abax Node Index (ANI) and Abax Node Store (ANS)

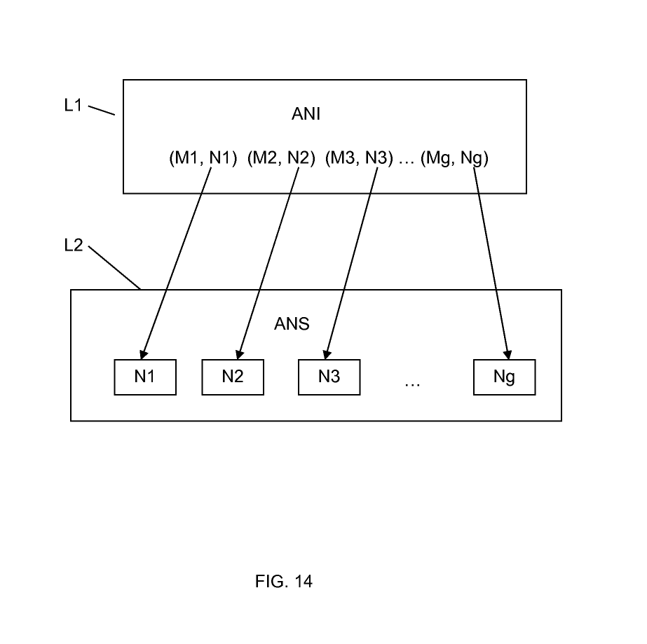

FIG. 14 is a schematic diagram illustrating Abax Node Index (ANI) and Abax Node Store (ANS). The storage structure that includes both ANI and ANS is named an ANIANS structure. Because an Abax node may store a large number of keys, the ratio between the number of Abax nodes and the total number of keys stored in memory could be very small. The ratio is actually equal to the multiplicative inverse of the average number of keys stored in an Abax node. If more keys are stored in one Abax node, the ratio becomes smaller. For instance, if an Abax node stores one million keys, then the ratio is one millionth. We build an index structure, ANI, to store key ranges and Abax node addresses as key-value pairs. Each Abax node has a range of keys. The range is determined by minimum key (lower bound) and maximum key (upper bound) in the node. Each range is mapped to a node address. In practice the key range defined by the lower bound and upper bound in the node is not needed since only the lower bound or the upper bound is sufficient to locate an Abax node from a given key. For instance, suppose node A has key range [a1, a2], node B has key range [b1, b2], node C has key range [c1, c2], . . . H has key range [h1, h2]. Only the lower bound (or upper bound), namely (a1, b1, c1, . . . h1), in the related nodes are necessary in ANI. We use ANS to denote the storage structure containing all the Abax nodes. The ANI is a data structure storing pairs of lower bound of an Abax node and the address of the node that contains the lower bound. In FIG. 14, L1 is an exemplary ANI which has pairs of (Mi, Ni) (i=1, 2, 3, . . . g) where g is the total number of Abax nodes for all the keys, i means the i-th node, Mi is the lower bound in node i, Ni is the address of node i. L2 is an Abax Node Store (ANS) which contains all the nodes (N1, N2, . . . Ng).

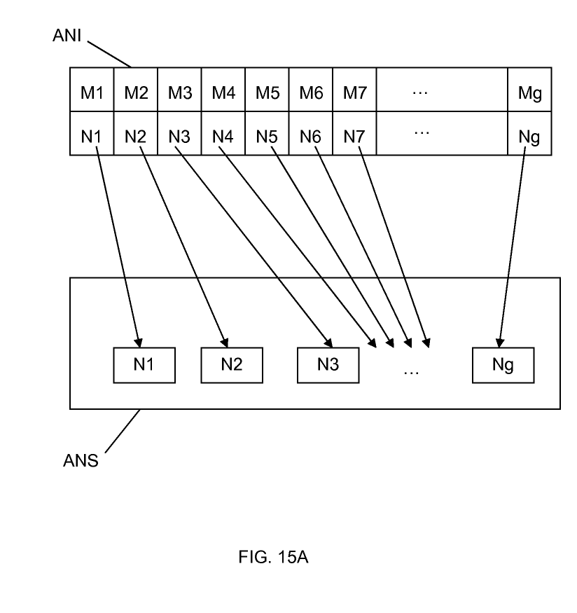

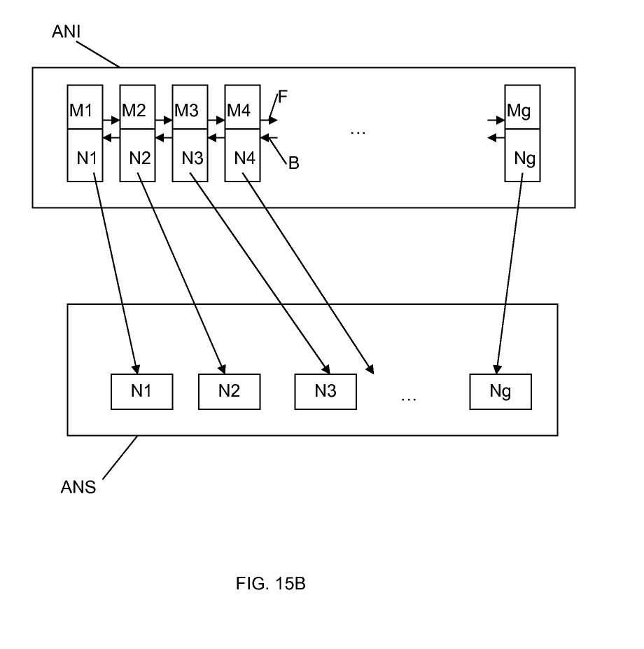

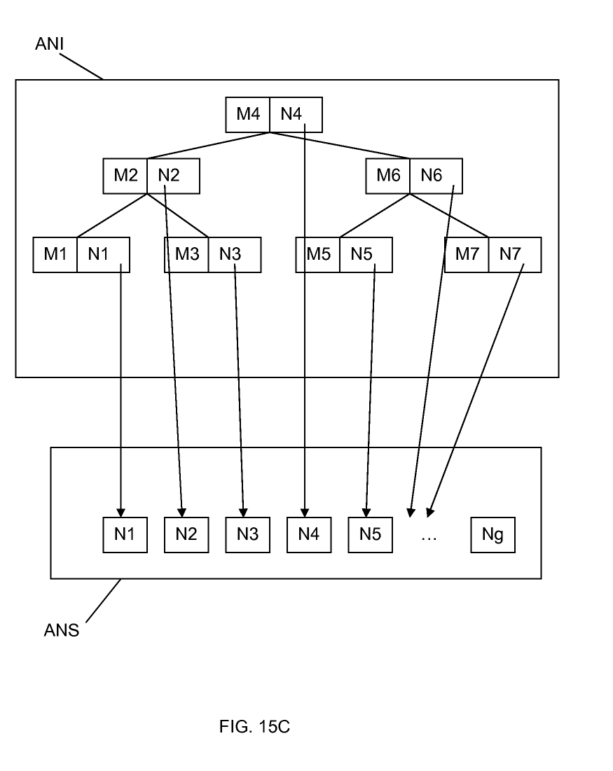

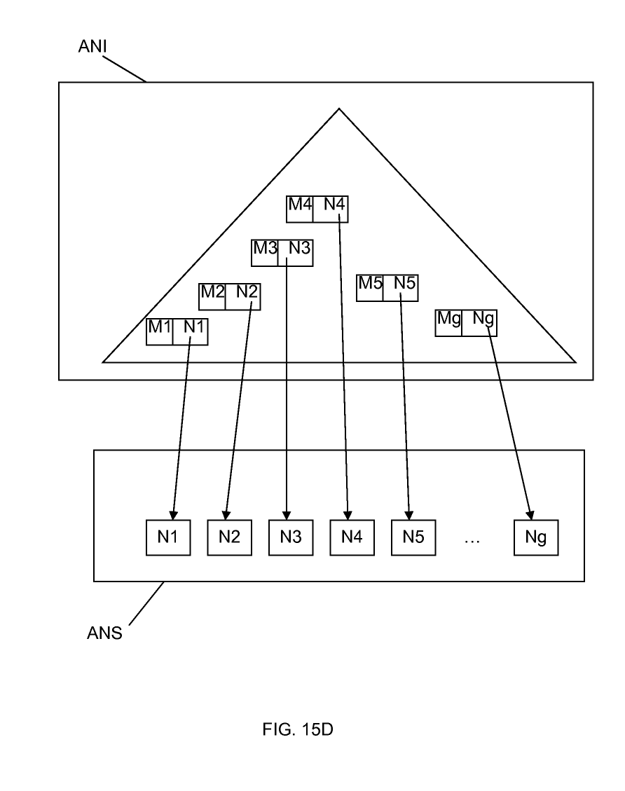

An embodiment of ANI is illustrated in FIG. 15A. A dynamic ordered array of pairs of lower bound and node address is used to store and retrieve a node address from a given lower bound key. The size of the array grows or shrinks dynamically as the number of node Abax nodes increases or decreases. The array is ordered by the lower bound keys. Each element in the array points to a node in ANS. One skilled in the art will appreciate that inserting and deleting elements in an array may require shifting other elements in the array, and searching for an element or a predecessor of an element in an ordered array may be achieved with binary search method.

Another embodiment of ANI is illustrated in FIG. 15B, where an ordered linked list of pairs of lower bound key and node address is maintained by forward pointers such F and backward pointer such as B. Each element in the list points to a node in ANS. One skilled in the art will appreciate that inserting and deleting elements in a linked list require constant time, and searching for an element or a predecessor of an element in a linked list takes linear time.

Another embodiment of ANI is illustrated in FIG. 15C, where a balanced binary search tree (BST) or multi-way search tree such as B−tree with nodes that contain pairs of lower bound key and node address is used. Each element in the tree points to a node in ANS. One skilled in the art will appreciate that inserting, deleting, or searching an element or predecessor in a BST takes logarithmic time.

In a preferred embodiment, the ANI is illustrated in FIG. 15D, where a SAT or CAT with nodes that contain pairs of lower bound key and node address is used. Each element in the tree points to a node in ANS. Operations of inserting, deleting, and searching an element in a SAT or CAT are explained previously. Other embodiments include any type of ordered map that allows fast searching of an element or a predecessor. If upper bound key is used in ANI, the operations work similarly except successor of a key may be needed.

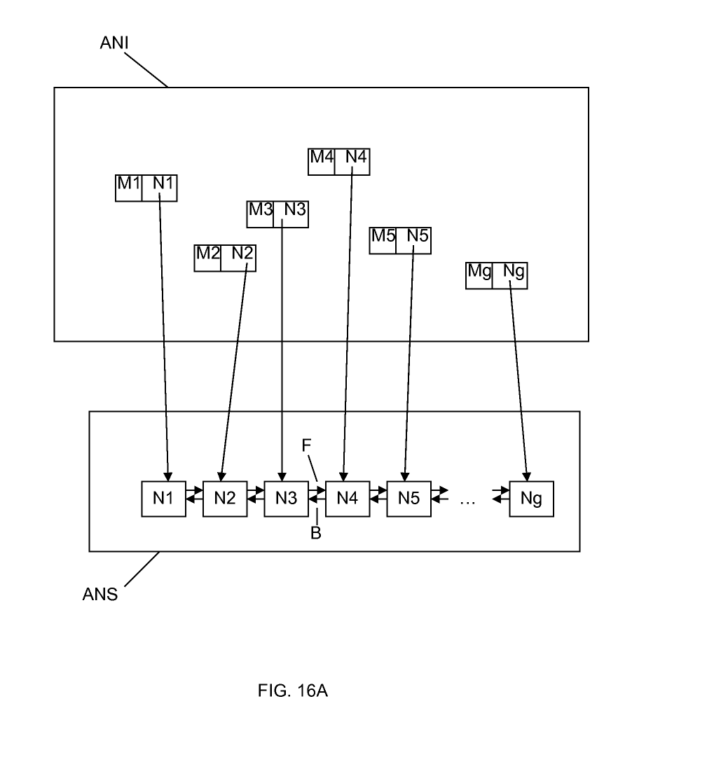

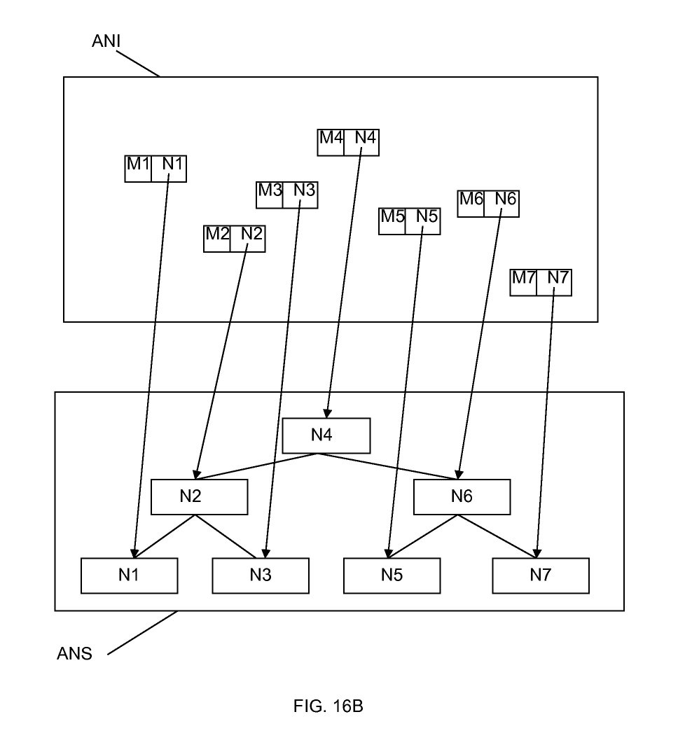

In an embodiment of Abax Node Store (ANS), the Abax nodes in ANS are linked with pointers to form an ordered linked list, as illustrated with an exemplary structure in FIG. 16A. A key-value pair (Mi, Ni) (i=1, 2, . . . g) in the ANI points to a node Ni in ANS. Forward pointers such as F link the nodes in one direction, while backward pointers B link nodes in the opposite direction. Keys in a node are greater than the keys that are in the nodes on the left side of the node.

In a preferred embodiment, as illustrated with an exemplary structure in FIG. 16B, the Abax nodes N1, N2, . . . N7 in ANS are organized with an Abax tree as described previously. A key-value pair (Mi, Ni) in the ANI points to a node Ni in the Abax tree. Because Abax trees provide tree depth information as opposed to the single-level flat linked list of Abax nodes, incorporating Abax tree in ANS allows for flexibility in controlling the size of Abax nodes when the depth of the tree changes.

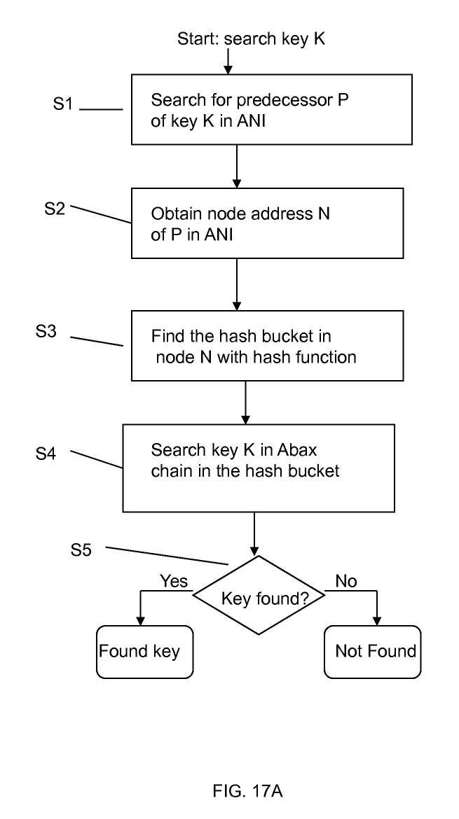

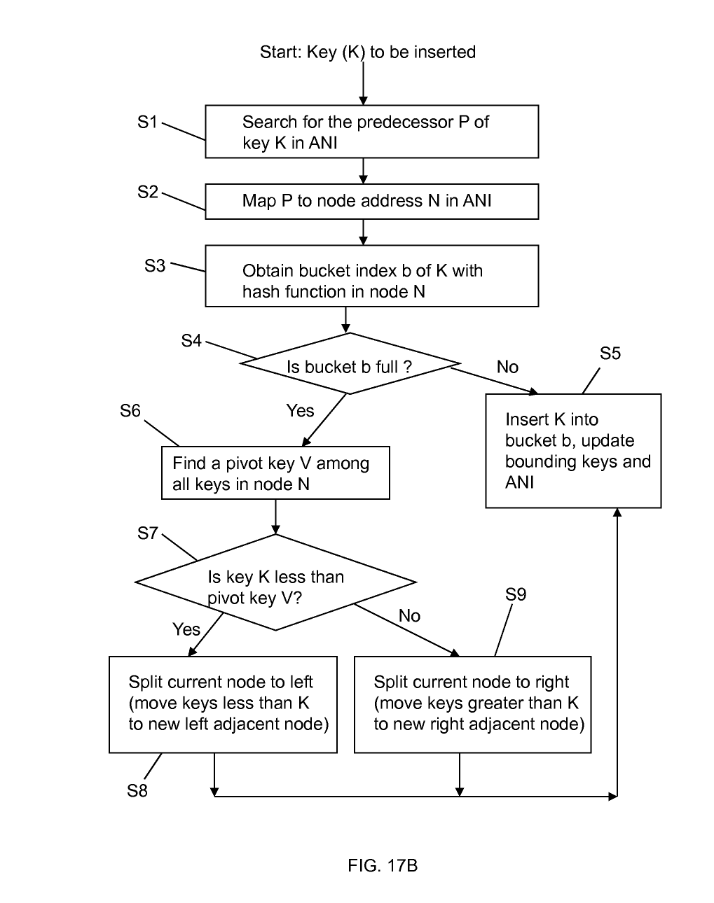

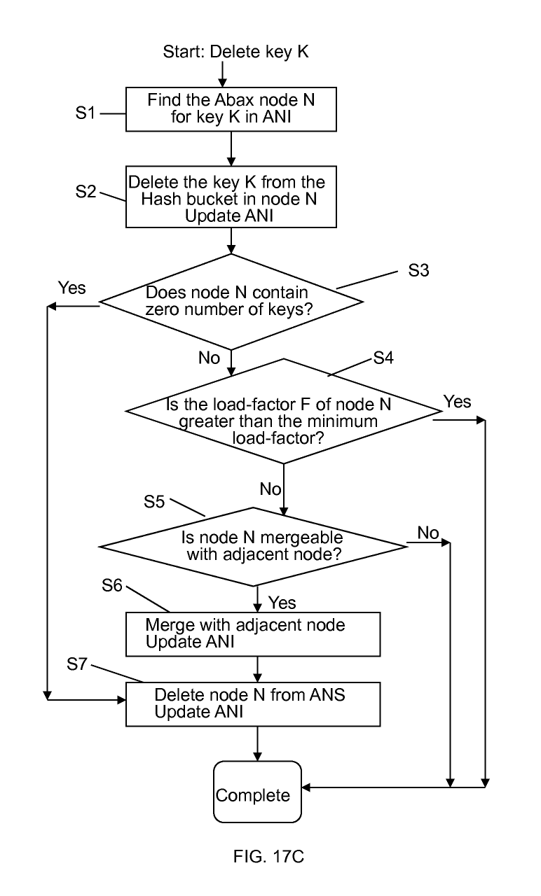

FIG. 17A is a flow diagram illustrating the method of searching for a key K in ANIANS storage structure. In step S1, the predecessor of key K is found in the ANI. In step S2, the node address of the predecessor is found by looking up the key-value pair in ANI. In step S3, the Abax node is located and the bucket is found for key K with the same hash function used in the node. In step S4, we search for the key K in the hash bucket.

FIG. 17B is a flow diagram illustrating an embodiment of inserting a key K into ANS that contains an ordered linked list of Abax nodes. In step S1, the predecessor of K is found in the ANI. In step S2, the node address of the predecessor is found. In step S3, the hash bucket index of the key K is obtained. In step S4, we test whether the bucket is full. If the bucket has sufficient storage space, we insert the key K into the bucket, as illustrated in step S5, and update the lower bound and upper bound keys in the node. Also we delete the old lower bound key from ANI and insert the new lower bound key in ANI together with the node address if the lower bound has been changed. If the bucket is full in step S4, then we find a pivot in the node with the same embodiment for finding a pivot when inserting a key in SAT (step S17 in FIG. 5) as illustrated in step S6. In step S7, we test whether key K is less than the pivot. If answer is yes, we split the current node into a new left neighbor node and move the keys that are less than the pivot to the new left node in step S8. The new left neighbor node is inserted between the node and its original left adjacent node. If the test result in step S8 is no, in step S9 we split the current node into a new right adjacent node and move the keys that are greater than the pivot to the new right node. The new right adjacent node is inserted between the node and its original right adjacent node. After step S8 and S9, control goes to step S5 to insert key K into corresponding bucket and update lower bound key and ANI if the lower bound key in the node is changed.

If Abax tree is incorporated in ANS, inserting a key into ANS follows the same procedure as explained in inserting a key in Abax tree illustrated in FIG. 4 except that we start from the node that is mapped through the ANI for the given key instead of the root node. Insert operation is executed from the Abax tree. As new Abax nodes are inserted, the ANI is updated with the lower bound key and address of the new node. If the lower bound in a node is changed, the old lower bound is removed from the ANI and the new lower bound is inserted into the ANI along with the address of the node.

It should be noted that when a node containing a key is mapped from the ANI, the key is always greater than or equal to the lower bound key in the node, but the key may be less than, equal to, or greater than the upper bound key stored in the node. This is true when ANI includes the lower bound keys. If the ANI includes the upper bound keys instead of the lower bound keys, then the key to be inserted is always less than or equal to the upper bound key in the node, but the key may be greater than, equal to, or less than the lower bound key stored in the node. If the ANI uses upper bound keys, then successor search of a key is needed.

FIG. 17C is a flow chart illustrating key delete operation from an ANS. In one embodiment we use the same procedure as illustrated in FIG. 12 except with these differences: 1) the Abax node is located from the ANI; 2) when a key is deleted, the ANI may need to be updated for new lower bound keys; 3) an Abax node is merged with its left or right neighbor nodes; 4) merging nodes may require the ANI to be updated by replacing old lower bound keys with new lower bound keys.

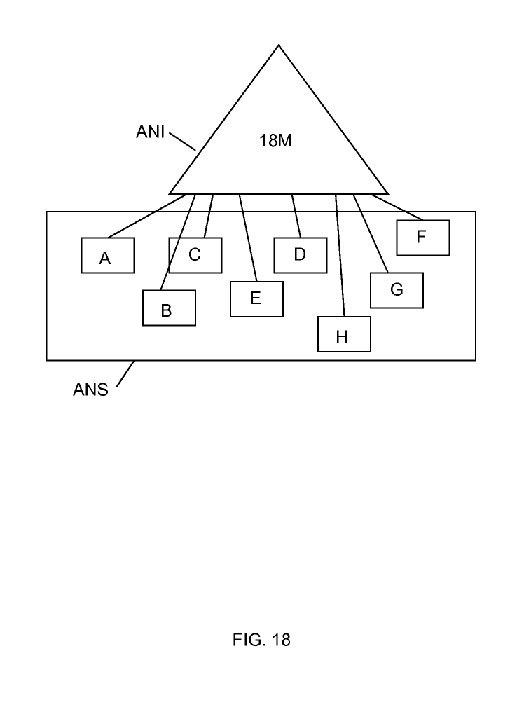

FIG. 18 is a schematic diagram illustrating one embodiment of data access in a two-level ANIANS storage system with an ANI. Abax nodes A, B, . . . H are stored in a ANS. The level here refers to the degree of speed in accessing to a type of memory. For instance, faster main memory coupled with slower magnetic disk is a two-level storage system. Level-one refers to the faster memory, while level-two refers to the slower memory. The ANS is normally stored in the level-two memory due to its large data size, while the ANI can be stored in level-one memory. Level-two instance of ANI is optional. If level-two ANI is built and maintained, level-one ANI is copied from and synchronized with its level-two counterpart. If level-two ANI is not built, level-one ANI is reconstructed from level-two ANS at initialization time. In a storage system with present disclosure, the ratio between the number of Abax nodes and the total number of keys stored in the system is generally very small. The small ratio makes it possible to use only a very small amount of fast speed memory to store the ANI. If the level-one memory is the main RAM memory in a computer system, and the level-two memory is magnetic disk, then it is possible to always take only one disk access to execute read or write operations to an Abax node on the disk.

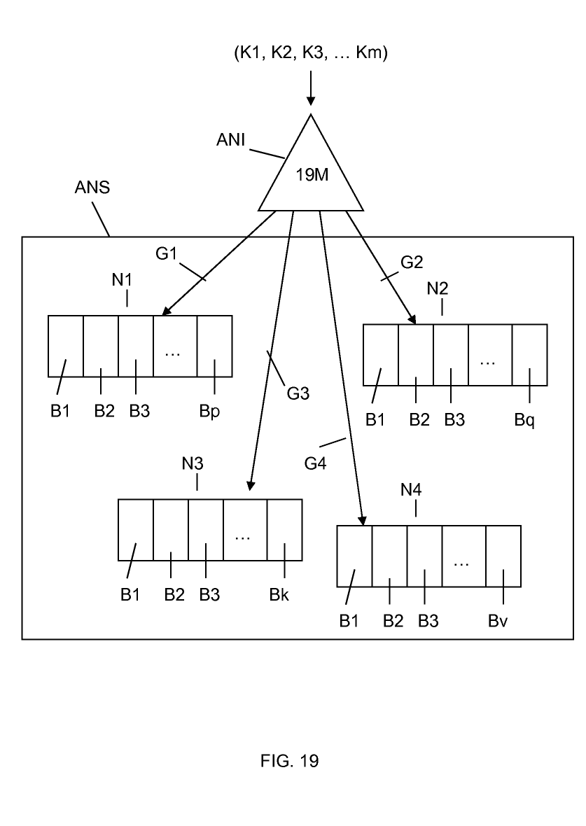

FIG. 19 is a block diagram illustrating buffered read or write operations, namely buffered IO or batch IO or delayed IO, in a two-level exemplary ANIANS storage structure where level-one is faster memory and level-two is slower block-based (or page-based) memory such as a magnetic disk. A set of keys (K1, K2, K3, . . . Km) that will be read from or written to level-two memory are first buffered in level-one memory. The keys then are mapped through the ordered key-value index store ANI 19M to the addresses of Abax nodes denoted by N1, N2, N3, and N4 in level-two memory. As a result, the keys K1, K2, K3, . . . Km are partitioned into groups of keys denoted by G1, G2, G3, and G4. Each group contains the address of the corresponding Abax node. The groups are sorted by the address of Abax nodes in a preferred disk access order. For instance, if nodes N1, N2, N3, and N4 are stored on magnetic disk and the order of N2, N1, N4, N3 gives optimal disk IO operation, then IO operation should be executed on the keys in group G2 first, then on the keys in group G1, G4 and finally in group G3. In each group, keys are again sorted according to their index to the buckets that are stored in a partial block, a whole block, or a plurality of blocks. The address of the storage blocks (B1, B2, B3 . . . ) determines the order of IO operation on keys in one group. Because of the availability of the level-one ANI and the compactly structured Abax node, IO operations on a batch of keys is improved in terms data locality and IO scheduling.

Range query is a search of a set of keys that are bound by low and high end points of a range. Range query and Abax node splits often require sorting of K ordered lists of keys, known as K-way sorting. The method for the K-way sorting is described in the following steps. Step one: creating a binary heap of size K. Step two: the first key in each ordered list is inserted into the binary heap. Step three: the head element from the binary heap is popped and inserted into the output list. Step four: from the list where the head element of the heap is fetched, the next key in the list is taken and inserted into the heap. Steps three and four are then repeated until all of the ordered lists are consumed. The final output list contains the sorted keys from all the lists.

Range query may also require search for the predecessor and the successor of a key. If the low end key and the high end key of a range all exist in an Abax tree, then we do not need to search for the predecessor and successor. However, if one of them cannot be found with equality search, then predecessor or successor search is required. The predecessor of a key is the key that precedes the key in an ordered list. The successor of a key is the key that succeeds the key in the ordered list. In range query, we find the successor, denote by S, of the low end point of the range and the predecessor, denoted by P, of the high end point of the range. Then the keys between S and P in a sorted list are returned as output.

We find the predecessor of key K with the following procedure. Step one: we locate the Abax node N where key K would be stored. A process similar to that of equality search illustrated in FIG. 3 is executed. Step two: we search for the predecessor in the node N located in step one. In accordance with order structure of the keys in the Abax chains (AC), we execute the search with different methods. If the keys in the chains are not connected with an ordered linked list, we execute a search in each chain to find the predecessor of key K, and then we find the maximum key among all the predecessors of each chain. The predecessor of K in each chain is called a local predecessor of K. The maximum key among all local predecessors is called the global predecessor of key K. If the keys in the Abax chains are connected with an ordered linked list as illustrated in FIG. 10, then we map the key K to a bucket and find the local predecessor of K in the bucket. Then starting from the local predecessor we traverse the ordered linked list until the global predecessor of K is found. In each bucket, we may use binary search to find the local predecessor and follow it to the next bucket and so on. The successor of key K can be found likewise.

### Mini-Hash Tables

In one embodiment, the present disclosure provides a new hash structure (referred to as a mini-hash table) that facilitates data indexing and search. It is noted that, even though such a mini-hash table can be used as a hash table for the Abax trees disclosed herein, such a mini-hash table can be independently used, or in combination with data structure other than Abax trees.

In some aspects, a mini-hash table includes (1) a first array (O[m]) that includes m keys where the keys are sorted in the first array, (2) a second array (E[m]) of at least the same size (m) as the first array, which second array includes, at each position (i), hash value of the key (O[i]) located at the same position (i) in the first array with a hash function (hash_f), that is, E[i]=hash_f(O[i]), and (3) a third array (I[n]) having a size (n) that is larger than the size (m) of the first array, wherein the values (E[i]'s) in the second array (E) are non-negative integers, and wherein the third array includes, at the E[i]th position, the position (i) of the key O[i] in the first array.

Once a mini-hash table is created, searching the table is quick and straight forward. For instance, one can first obtain the hash value (h) of a query key with the hash function, followed by obtaining the value at position (h) of the third array, I[h]; and then locating the query key at position (I[h]) of the first array.

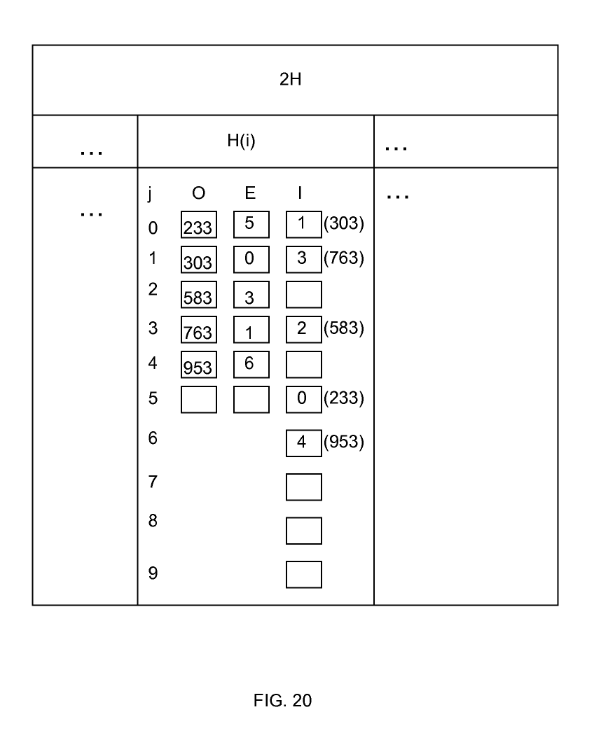

Such a mini-hash table is illustrated in FIG. 20, in the context of being used in an Abax tree. H(i) represents the i-th bucket in a node (FIG. 2). In the bucket H(i), O illustrates an array of size M holding the sorted keys. E and I are two arrays. The size of array E is the same as that of array O. The size of the array I, denoted by N, is greater than that of array E. Array index numbers are represented by j where J=0, 1, . . . M−1 for arrays O and E, or j=0, 1, 2, 3, . . . N−1 for array I.

The keys in array O are hashed with a second hash function, and the hashed value is the index to array I. The values in array I are the index position of the keys in array O. For example, key 303 has a hash value of zero through the second hash function. Key 303 has index position of 1 in array O. So the value of array I at index position O is set to 1. The values in array I may be represented by the following equation:

I[j]=m and f2(O[m])=j

Where j=0, 1, . . . N−1; m=0, 1, 2, . . . M−1; and f2 is the second hash function.

Array E contains the indices to the array I for the keys in array O. The values of array E may be represented by the following equation:

E[j]=f2(O[j])

For example, key 953 has index position 4 in array O. By applying hash function f2( ) the hash value of key 953 is 6. Therefore, I[6]=4 and E[4]=6.

Linear probing may be used when collision occurs in array I. When the size of array I increases, the probability of collision in array I becomes smaller. The ratio of N/M should be properly maintained to avoid high probability of collision and high rate of probing.

Array I provides direct random access to keys in array O, without resorting to binary search in the bucket. Array E, as an optional data structure, stores the hashed values of keys from the second hash function without the need of re-hashing the keys that are shifted in array O during insert or delete operations in the bucket. Arrays of I and E use minimal amount of memory. If the size of array O is small (for example, less than 128), then only one byte of memory maybe needed for each element in arrays I and E.

They add relatively a very small amount of memory overhead to the entire dataset, especially when the size of each key is substantially greater than one byte. The values in arrays E and I need be maintained properly during insertion, deletion, and node-split operations.

As noted, the size (n) of the third array (array I), in some aspects, is larger than that of the first and second arrays. In one aspect, the ratio between the sizes of the third and first arrays is at least 1.2, 1.3, 1.4, 1.5, 1.6, 1.7, 1.8, 1.9, or 2 fold.

The mini-hash table described here can be incorporated into data structures, such as binary trees, B−trees, B+trees or Abax trees, without limitation. In one aspect, the data structure includes a tree having a plurality of nodes and each node comprises at least a hash structure of step (a), and wherein the nodes do not overlap in terms of ranges of keys stored in each hash structure.

Like the conventional hash tables, collision can happen in a mini-hash table. That is, some keys in O(m) can hash to the same value, leading to collision. For example, key 1 may hash to number 13, and key 8 may also hash to number 13. In such an occasion, the disclosure also provides methods to resolve the collision.

For instance, in B−trees and B+trees for instance, keys arrived later overwrite the previous key(s) that hashed to the same value. As an example, key 8 takes hash value 13, and I[13] would be 8 (for key 8). Key 1 is presumably non-existing from the hash structure, and then binary search is resorted to locate key 1. So a positive answer from the hash structure tells that a query key really exists. However a negative answer from the hash structure does not mean a query does not exist in the array O(m) (due to collision and overwriting). In this case a regular binary-search can be performed to search for a query key or its predecessor/successor. In a binary Abax tree case, then the collision can be resolved by linear probing, known in the art.

### Computer Systems and Network

The methodology described here can be implemented on a computer system or network. A suitable computer system can include at least a processor and memory; optionally, a computer-readable medium that stores computer code for execution by the processor. Once the code is executed, the computer system carries out the described methodology.

In this regard, a “processor” is an electronic circuit that can execute computer programs. Suitable processors are exemplified by but are not limited to central processing units, microprocessors, graphics processing units, physics processing units, digital signal processors, network processors, front end processors, coprocessors, data processors and audio processors. The term “memory” connotes an electrical device that stores data for retrieval. In one aspect, therefore, a suitable memory is a computer unit that preserves data and assists computation. More generally, suitable methods and devices for providing the requisite network data transmission are known.

Also contemplated is a non-transitory computer readable medium that includes executable code for carrying out the described methodology. In certain embodiments, the medium further contains data or databases needed for such methodology.

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above also come within the scope of “machine-readable media.” Machine-executable instructions comprise, for example, instructions and data that cause a general purpose computer, special-purpose computer or special-purpose processing machine(s) to perform a certain function or group of functions.

Embodiments of the present disclosure have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present disclosure may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the disclosure also may be practiced in distributed and cloud computing environments where tasks are performed by local and remote processing devices that are linked, by hardwired links, by wireless links or by a combination of hardwired or wireless links, through a communications network. In a distributed computing environment, program modules may be located in both local and remote memory storage devices.

Although the discussions above may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure. Such variations will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this disclosure belongs.

The disclosures illustratively described herein may suitably be practiced in the absence of any element or elements, limitation or limitations, not specifically disclosed here. For example, the terms “comprising”, “including,” containing,” etc. shall be read expansively and without limitation. Additionally, the terms and expressions employed here have been used as terms of description and not of limitation; hence, the use of such terms and expressions does not evidence and intention to exclude any equivalents of the features shown and described or of portions thereof. Rather, it is recognized that various modifications are possible within the scope of the disclosure claimed.

By the same token, while the present disclosure has been specifically disclosed by preferred embodiments and optional features, the knowledgeable reader will apprehend modification, improvement and variation of the subject matter embodied here. These modifications, improvements and variations are considered within the scope of the disclosure.

The disclosure has been described broadly and generically here. Each of the narrower species and subgeneric groupings falling within the generic disclosure also form part of the disclosure. This includes the generic description of the disclosure with a proviso or negative limitation removing any subject matter from the genus, regardless of whether or not the excised material is described specifically.

Where features or aspects of the disclosure are described by reference to a Markush group, the disclosure also is described thereby in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

Although the disclosure has been described in conjunction with the above-mentioned embodiments, the foregoing description and examples are intended to illustrate and not limit the scope of the disclosure. Other aspects, advantages and modifications within the scope of the disclosure will be apparent to those skilled in the art to which the disclosure pertains.

1. A method of searching a query key in a data storage, comprising:
(a) Accessing, by a computer, a binary tree comprising a plurality of nodes,
wherein at least one of the nodes is a root node, each node has no more than two child nodes, a left child node and a right child node, and at least one node that is not the root node has both child nodes, and
wherein each node comprises a hash table to store one or more keys, all of which are greater than all keys stored in the left child node, if any, thereof, and are smaller than all keys stored in the right child node, if any, thereof;
(b) determining, starting at the root node, whether the query key is between the largest key and the smallest key stored in the node; and
(c) if the query key is greater than the largest key in the node, (i) repeating steps (b) and (c) at the right child node thereof or (ii) terminating the search if no right child node exists, thereby determining that the query key does not exist in the binary tree,
if the query key is smaller than the smallest key in the node, (i) repeating steps (b) and (c) at the left child node thereof or (ii) terminating the search if no left child node exists, thereby determining that the query key does not exist in the binary tree,
if the query key is not greater than the largest key and not smaller than the smallest key in the node, searching the node to (i) find the query key or (ii) determine that the query does not exist in the binary tree if the query key is not found in the node.

2. The method of claim 1, wherein the hash table in each node comprises a plurality of buckets, each bucket configured to store one or more keys.

3. The method of claim 2, wherein each key is further associated with a forward reference directed at the smallest key of all keys, if any, in the hash table that are greater than the key and a backward reference directed at the largest key of all keys, if any, in the hash table that are smaller than the key.

4. The method of claim 2, wherein the keys in each bucket are sorted.

5. The method of claim 3, wherein each bucket is configured to be capable to store at least D keys, wherein D is greater than 128.

6. The method of claim 1, wherein the binary tree comprises at least four layers of nodes.

7. The method of claim 1, wherein each node comprises a reference directed at each of the parent and child nodes thereof and each of the parent and child nodes thereof comprises a reference directed at said node.

8. A computer system comprising a processor, memory and program code which, when executed by the processor, configures the system to:
(a) access a binary tree comprising a plurality of nodes,
wherein at least one of the nodes is a root node, each node has no more than two child nodes, a left child node and a right child node, and at least one node that is not the root node has both child nodes, and
wherein each node comprises a hash table to store one or more keys, all of which are greater than all keys stored in the left child node, if any, thereof, and are smaller than all keys stored in the right child node, if any, thereof;
(b) determine, starting at the root node, whether the query key is between the largest key and the smallest key stored in the node; and
(c) if the query key is greater than the largest key in the node, (i) repeat steps (b) and (c) at the right child node thereof or (ii) terminate the search if no right child node exists, thereby determining that the query key does not exist in the binary tree,
if the query key is smaller than the smallest key in the node, (i) repeat steps (b) and (c) at the left child node thereof or (ii) terminate the search if no left child node exists, thereby determining that the query key does not exist in the binary tree,
if the query key is not greater than the largest key and not smaller than the smallest key in the node, search the node to (i) find the query key or (ii) determine that the query does not exist in the binary tree if the query key is not found in the node.

9. A method of searching a query key in a data storage, comprising:
(a) accessing, by a computer, a hash structure in the storage, which hash structure comprises (1) a first array (O[m]) that comprises m keys where the keys are sorted in the first array, (2) a second array (E[m]) of at least the same size (m) as the first array, which second array comprises, at each position (i), hash value of the key (O[i]) located at the same position (i) in the first array with a hash function (hash_f), that is, E[i]=hash_f(O[i]), and (3) a third array (I[n]) having a size (n) that is larger than the size (m) of the first array, wherein the values (E[i]'s) in the second array (E) are non-negative integers, and wherein the third array comprises, at the E[i]th position, the position (i) of the key O[i] in the first array;
(b) obtaining the hash value (h) of the query key with the hash function;
(c) obtaining the value at position (h) of the third array, I[h]; and
(d) locating the query key at position (I[h]) of the first array.

10. The method of claim 9, wherein the size (n) of the third array is at least 1.3 times of the size (m) of the first array.

11. The method of claim 10, wherein the data storage comprises a tree having a plurality of nodes and each node comprises at least a hash structure of step (a), and wherein the nodes do not overlap in terms of ranges of keys stored in each hash structure.

12. The method of claim 11, wherein the tree is a binary tree.

13. The method of claim 11, wherein the tree is a B−tree.

14. The method of claim 11, wherein the tree is a B+tree.
